(19) United States
(12) Patent Application Publication
(10) Pub. No.: US 2014/0200940 A1
(43) Pub. Date: Jul. 17, 2014

(54) Automated Meeting Time Availability Searching and Rescheduling of Meetings

(71) Applicant: CISCO TECHNOLOGY, INC., San Jose, CA (US)

(72) Inventors: David Putterman, Boxborough, MA (US); John Russell, Boxborough, MA (US); Brian Glanville, Boxborough, MA (US); Konstas Yannakopoulos, Boxborough, MA (US); Dhiren Patel, Boxborough, MA (US)

(73) Assignee: CISCO TECHNOLOGY, INC., San Jose, CA (US)

(21) Appl. No.: 13/740,552

(22) Filed: Jan. 14, 2013

(51) Int. Cl. G06Q 10/10

(52) U.S. Cl. CPC G06Q 10/1095
USPC 705/7.16

(57) ABSTRACT

Presented herein are techniques for automatically rescheduling one or more meetings in order to make a time slot available for scheduling of a meeting, e.g., a high priority urgent meeting. At a server that manages calendars for a plurality of users, a request is received to schedule a meeting between a first user and one or more other users. It is determined whether there is at least one other meeting involving any of the one or more other users that conflicts with the meeting. If so, the at least one other meeting is automatically rescheduled to another time.

### TECHNICAL FIELD

The present disclosure relates to meeting scheduling.

### BACKGROUND

Calendaring software is in widespread use in businesses to schedule meetings among individuals and to organize people's schedules. Nearly all of these calendar software tools are kept up to date and allow people within an organization to see each other's availability.

When scheduling an important time-sensitive meeting with a group of individuals it is often very difficult to find an open time in the immediate future slot that everyone can attend. Often, there is no option other than scheduling an overlapping meeting or scheduling a meeting for days or weeks in the future. This poses a real challenge in fast-acting modern business environments.

### BRIEF DESCRIPTION OF THE DRAWINGS

FIG. 1 is a block diagram of a calendaring system in which one or more meetings that conflict with a high priority/urgent meeting are automatically rescheduled to make a time slot available for the high priority/urgent meeting.

FIGS. 2A, 2B and 2C are diagrams showing calendars for multiple users and illustrating a first scenario for which a conflicting meeting is automatically rescheduled to make a time slot available for the high priority/urgent meeting.

FIGS. 3A, 3B, 3C and 3D are diagrams showing calendars for multiple users and illustrating a second scenario for which two conflicting meetings are automatically rescheduled to make a time slot available for the high priority/urgent meeting.

FIGS. 4A, 4B, 4C and 4D are diagrams showing calendars for multiple users and illustrating a third scenario for which a meeting conflicting with the high priority/urgent meeting and another meeting not directly conflicting with the high priority/urgent meeting are automatically rescheduled to make a time slot available for the high priority/urgent meeting.

FIG. 5 is a flow chart generally illustrating a method for automatically rescheduling one or more meetings in order to make a time slot available for the high priority/urgent meeting.

FIG. 6 is a more detailed block diagram illustrating an example deployment for a calendar system configured automatically reschedule meetings to make a time slot available for the high priority/urgent meeting.

### DESCRIPTION OF EXAMPLE EMBODIMENTS

### Overview

Presented herein are techniques for automatically rescheduling one or more meetings in order to make a time slot available for scheduling of a meeting, e.g., a high priority urgent meeting. At a server that manages calendars for a plurality of users, a request is received to schedule a meeting between a first user and one or more other users. It is determined whether there is at least one other meeting involving any of the one or more other users that conflicts with the meeting. If so, the at least one other meeting is automatically rescheduled to another time.

### Example Embodiments

Presented herein are techniques to allow a person to immediately schedule a meeting in such a way that it can be substantially guaranteed that there will not be any scheduling conflict with all of the invited meeting attendees. This is particularly useful when scheduling an urgent meeting with little advanced notice.

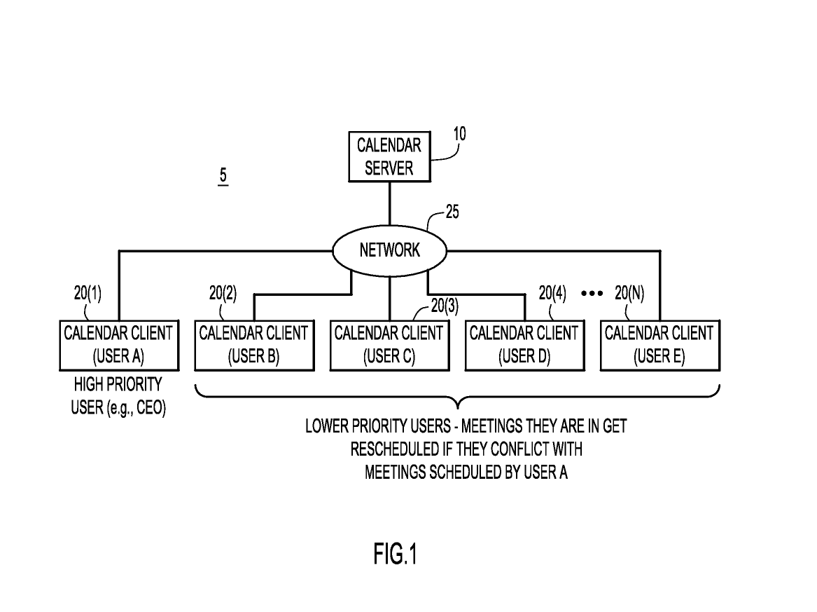

Referring first to FIG. 1, a system 5 is shown that includes a calendar server 10 and a plurality of calendar clients 20(1)-20(N) that communicate with the calendar server 10 via network 15. The network 15 may be one or any combination of a local area network, wide area network, wireless network, and wired network. Each calendar client 20(1)-20(N) may reside on a user device, such as a desktop computer, laptop computer, tablet computer, cellular “smart” phone, etc., or a user application space in a virtualized computing environment that is accessible from any type of user device. The calendar server 10 may be local to one or more of the calendar clients 20(1)-20(N), or completely remote from all of the calendar clients 20(1)-20(N). The functionality of the calendar server 10 and/or the calendar clients 20(1)-20(N) may be integrated into an application server that includes other functions, such as email, as is the case with the Microsoft Outlook® software. Moreover, the calendar server 10 and/or the calendar clients 20(1)-20(N) may be virtualized and resident in a data center of a cloud computing network. Regardless of the specific implementation, the calendar server 10 manages the digital calendars for a plurality of users (by way of each user's calendar client). Digital or electronic messages are exchanged between users by way of their calendar clients and the calendar server 10 in order to request to schedule a meeting, reschedule meetings, send notifications regarding rescheduled meetings, etc.

According to the techniques presented herein, at least one of the calendar clients 20(1)-20(N) is associated with a relatively “high” priority user. In the example of FIG. 1, user A is a high priority user, and users B-E are relatively lower priority users. For example, in a business organization, a senior executive manager or CEO may be designated as a high priority user. When user A sends a request (e.g., email or other electronic request) to schedule a meeting, any meetings that users B-E are scheduled to attend which conflict with the meeting user A is scheduling are rescheduled to another time that does not conflict with user A's meeting. In other words, the relatively high priority nature of a meeting requested by user A is determined by virtue of a meeting request being sent by or on behalf of user A to the meeting server. Information is stored at the calendar server 10 indicating that a user is designated as having relatively high priority for purposes of meeting scheduling. There may be multiple persons in a business organization who are designated as having relatively high priority for purposes of meeting scheduling, and there may be multiple levels of priority such that a meeting request by one user may be higher in priority than a meeting already scheduled by another high priority user.

Alternatively, a configuration may be used in which any user can send a relatively high priority meeting request by including an indication in the meeting request itself to indicate that the meeting request is be treated as a high priority/urgent meeting such that other meetings already scheduled which conflict (overlap) with the high priority/urgent meeting requested should be automatically rescheduled.

When a meeting is being scheduled for/by a high priority user, the schedules of all of the invited users will be searched. If there is not an open block of free time for all invitees that overlaps, then the first available time-slot that could be created by moving one or more other meetings is determined.

In one example, the software capability to perform this technique resides with the calendar server 10. However, it is also possible that this function may reside with each calendar client 20(1)-20(N) and be invoked by each calendar client, when that calendar client is associated with a high priority user.

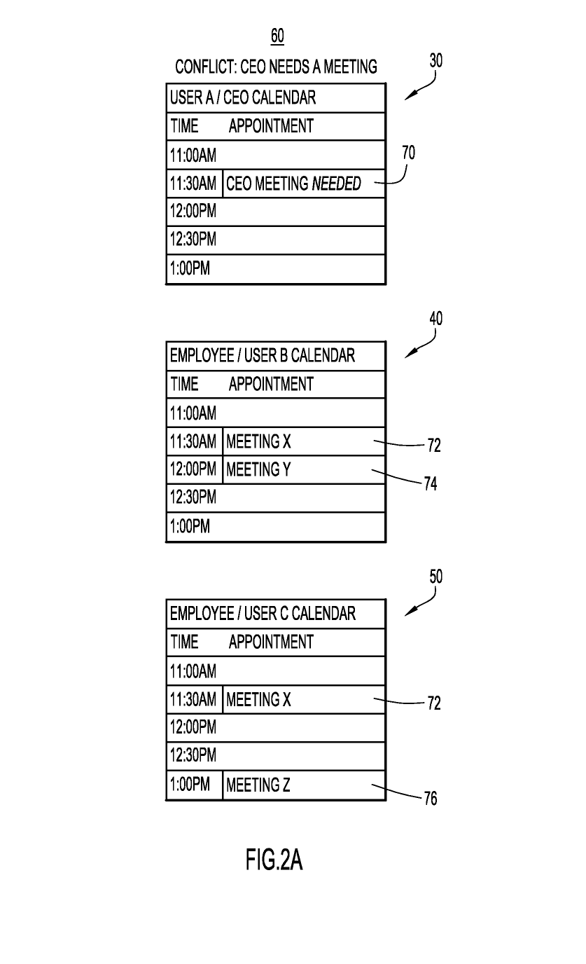

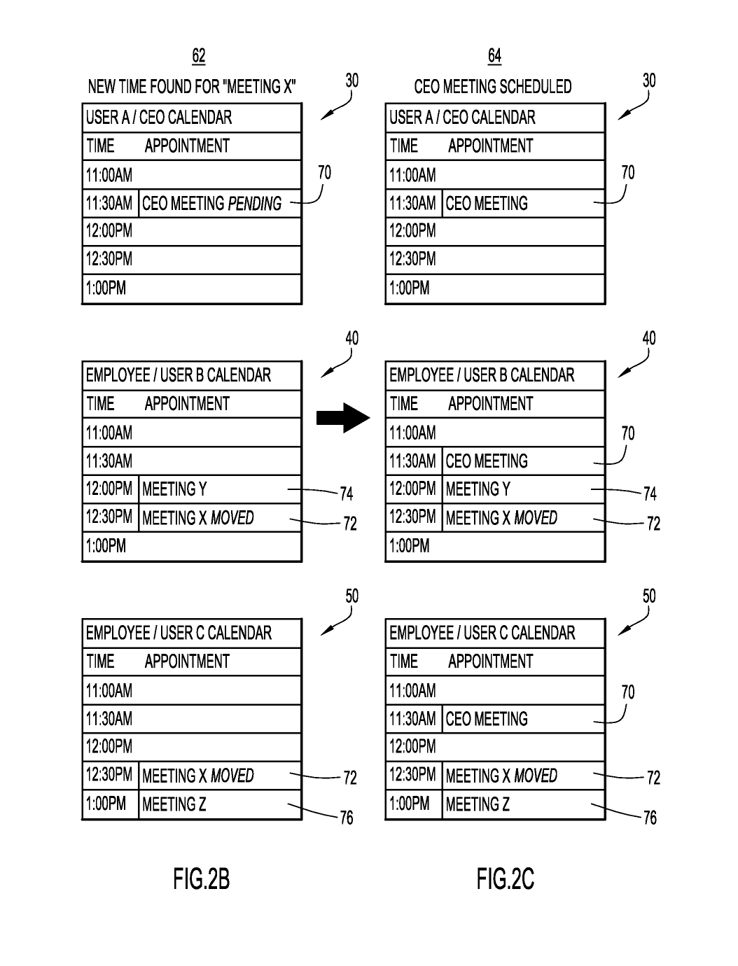

Reference is now made to FIGS. 2A-2C for a description of a first simple example. The calendar for a portion of a given day is shown for each of user A, e.g., a CEO, who is a high priority user, and for two other lower priority users, user B and user C. User A's calendar is shown at reference numeral 30, user B's calendar at reference numeral 40 and user B's calendar at reference numeral 50. Each of these calendars is shown at three phases/stages 60, 62 and 64 of the process. FIG. 2A shows phase 60, FIG. 2B shows phase 62 and FIG. 2C shows phase 64.

At phase 60, user A sends a request to schedule a meeting with user B and user C at 11:30 AM on a given day, perhaps that same day. This meeting request is shown at reference numeral 70. Thus, user A's meeting may be deemed a high priority urgent meeting because it is being scheduled by/for user A based on user A's status in the organization (i.e., CEO) and/or based on the relative short notice/urgency of the meeting. As a further alternative, the meeting request may be specifically designated as a “high” priority meeting in order to cause other conflicting meetings to be rescheduled, as described above. User B and User C already have “Meeting X” shown at reference numeral 72 scheduled at 11:30 AM. User B also has “Meeting Y” shown at reference numeral 74 already scheduled at 12:00 PM. Similarly, User C has “Meeting Z” shown at reference numeral 76 scheduled at 1:00 PM. Thus, there is a conflict between user A's meeting at 11:30 AM and user B's “Meeting X” scheduled at 11:30 AM.

Having determined that Meeting X conflicts with user A's meeting requested at 11:30 AM, next at phase 62, the availability of another time for rescheduling Meeting X is determined in order to make user B's calendar free for user A's meeting. All attendee/invitee schedules are searched to determine when the overlapping/conflicting meeting 72 could be moved, preferably within a predetermined period of time period, one or two days, of the originally scheduled time of Meeting X. This predetermined period of time may be system/user programmable. Multiple meetings may be moved/rescheduled, if necessary, in order to make an invitee's schedule available for a high priority/urgent meeting. In the example of FIG. 2B, at phase 62, it is determined that Meeting X can be moved to 12:30 PM on the same day, and its status is changed to “pending” as shown in the figure. In FIG. 2C, at phase 64, Meeting X is rescheduled to 12:30 PM, the CEO meeting at 11:30 AM is scheduled, and a notification is sent to user B and user C to inform them that Meeting X has been rescheduled to 12:30 PM. The notification may include an explanation of the reason for the rescheduling, i.e., that user A had a high priority meeting to schedule at 11:30 AM. For all the meetings that were moved to make time for user A's meeting, the meetings are moved automatically and notifications are automatically sent to all users/attendees of the changed meeting. The calendar server may send invites/updates and move the event in each user's calendar.

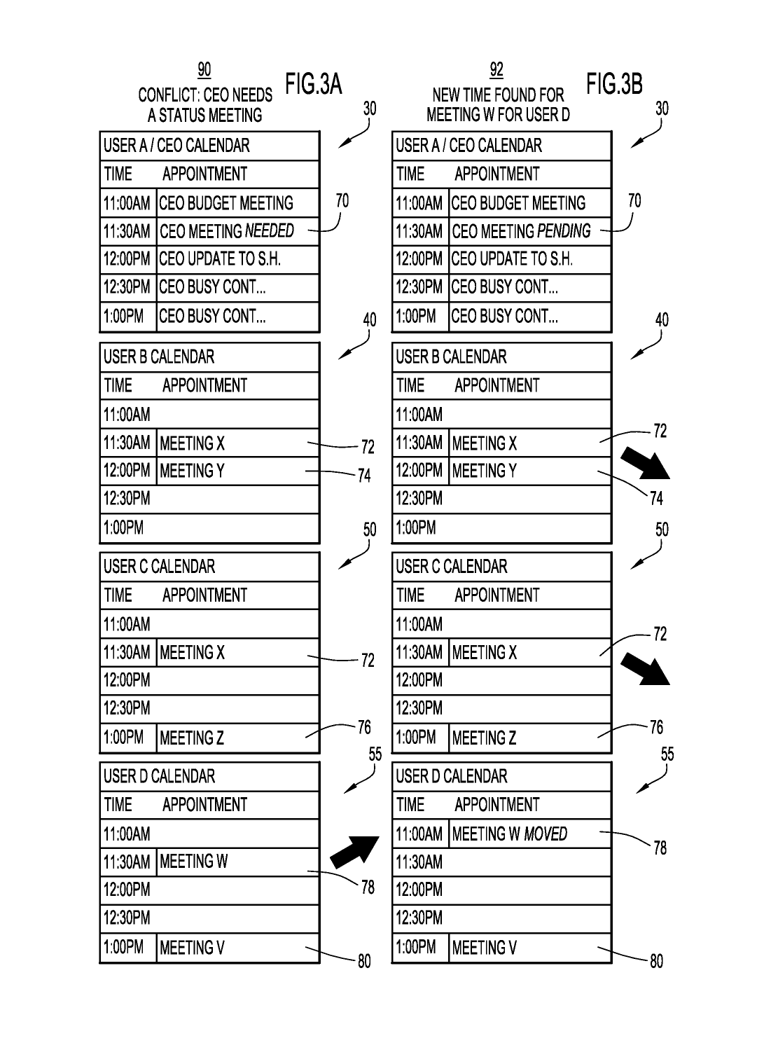

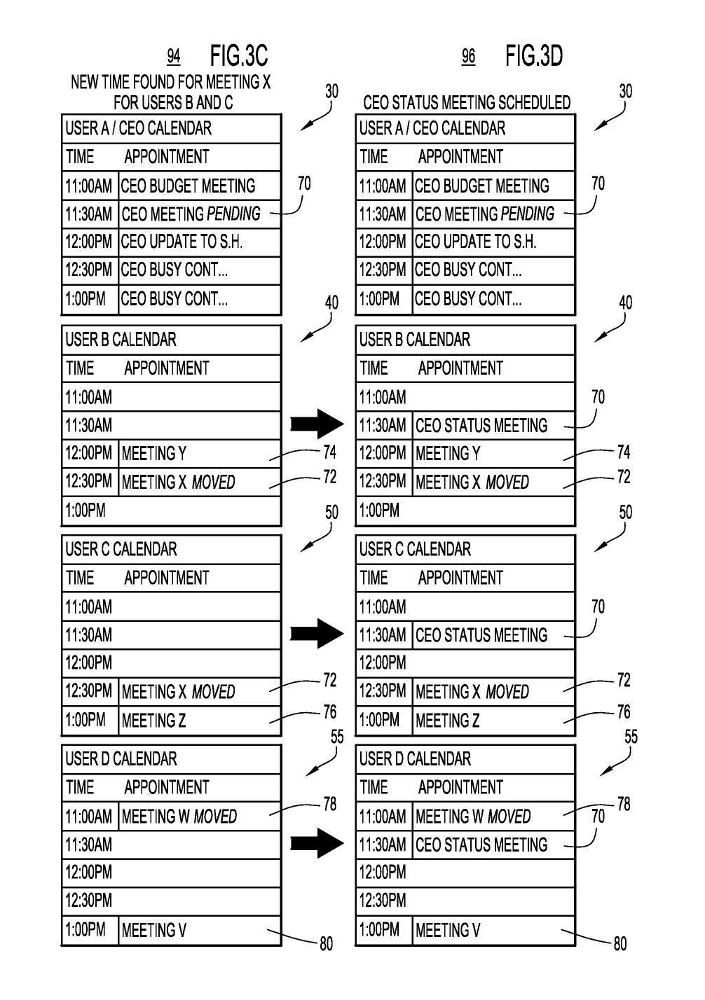

Reference is now made to FIGS. 3A-3D. FIGS. 3A-3D show an example of a more complex rescheduling scenario. In this example, there is an additional user, user D, whose calendar is shown at reference numeral 55. Like the example of FIGS. 2A and 2B, user A, the CEO, desires to schedule an urgent meeting at 11:30 AM and users B and C have a conflict with Meeting X shown at reference numeral 72 at that time. There are also Meetings Y and Z shown at reference numerals 74 and 76 like that shown in FIGS. 2A-2C. In addition, user D has a Meeting W shown at reference numeral 78 scheduled at 11:30 AM that also conflicts with user A's desired urgent meeting at 11:30 AM, and Meeting V shown at reference numeral 80 scheduled at 1:00 PM. Thus, in the example of FIGS. 3A-3D, there are two meetings that conflict with the high priority user's desired urgent meeting: Meeting X shown at reference numeral 72 that involves two participants/attendees of user A's urgent meeting, user B and user C; and Meeting W shown at reference numeral 78 that involves one participant/attendee of user A's urgent meeting, user D.

There are four phases/stages to the rescheduling scenario of FIGS. 3A-3D: phase 90 shown in FIG. 3A, phase 92 shown in FIG. 3B, phase 94 shown in FIG. 3C and phase 96 shown in FIG. 3D. Phase 90 involves the initial meeting request being sent to and received at the meeting server for user A's high priority/urgent meeting 70 at 11:30 AM involving users B, C and D. Upon searching through the stored data for calendars 30, 40 and 55, the meeting server 10 determines that there are two conflicting meetings with meeting 70, Meeting X and Meeting W. At phase 92 shown in FIG. 3B, the meeting server searches through the stored data for the calendar 55 for user D and finds an available time slot, within a predetermined time period from Meeting W, at 11:00 AM, and thus reschedules Meeting W to 11:00 AM. In this example, users A, B and C are not attendees of Meeting W so this rescheduling operation of Meeting W does not affect the calendars for these users. Next, at phase 94 shown in FIG. 3C, the meeting server 10 searches through the stored data for calendars 40 and 50 for users B and C, respectively, to find an available new time slot for Meeting X. The meeting server 10 finds a new time slot for Meeting X at 12:30 PM, and reschedules Meeting X for this new time slot as shown at phase 94. Finally, as shown at phase 96 shown in FIG. 3D, user A's meeting 70 is scheduled at 11:30 AM, Meeting X is moved to 12:30 PM and Meeting W is moved to 11:00 AM. Meeting Y and Meeting V did not need to be rescheduled because they did not conflict with user A's urgent meeting. The meeting server 10 sends out updated meeting invitations/notifications to users B and C for the rescheduling of Meeting X, and also sends out an update meeting invitation/notification to user D (and to all other participants, not shown in FIGS. 3A-3D) of Meeting W. Thus, FIGS. 3A-3D show an example of a scenario in which two other meetings conflict with the high priority/urgent meeting and are automatically rescheduled to make a time slot available for the urgent meeting.

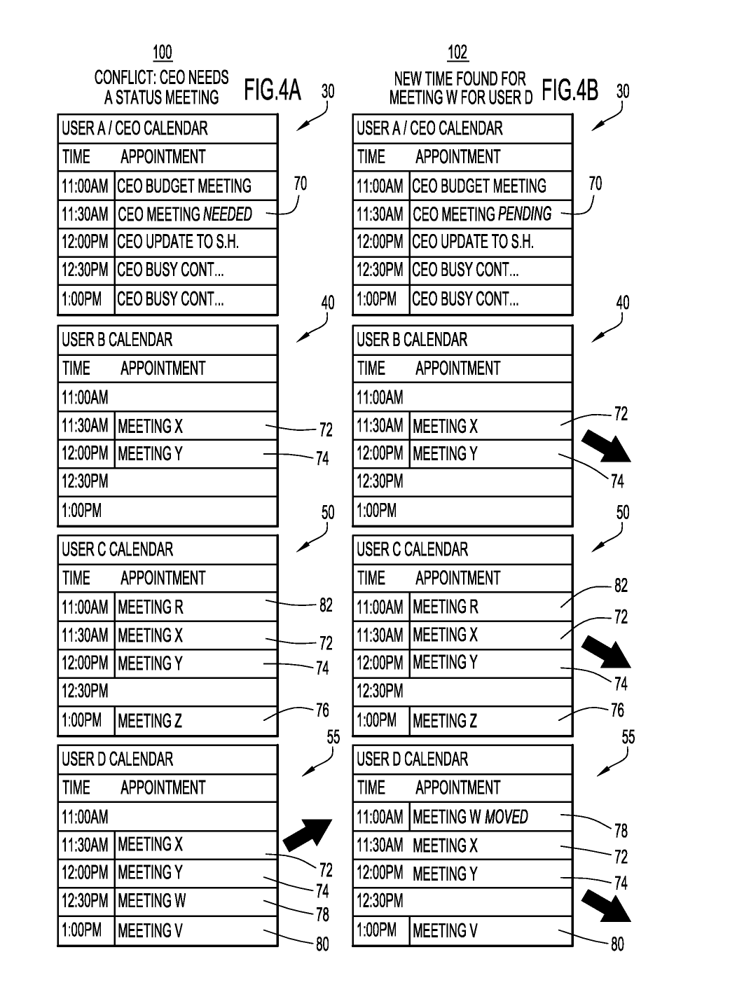

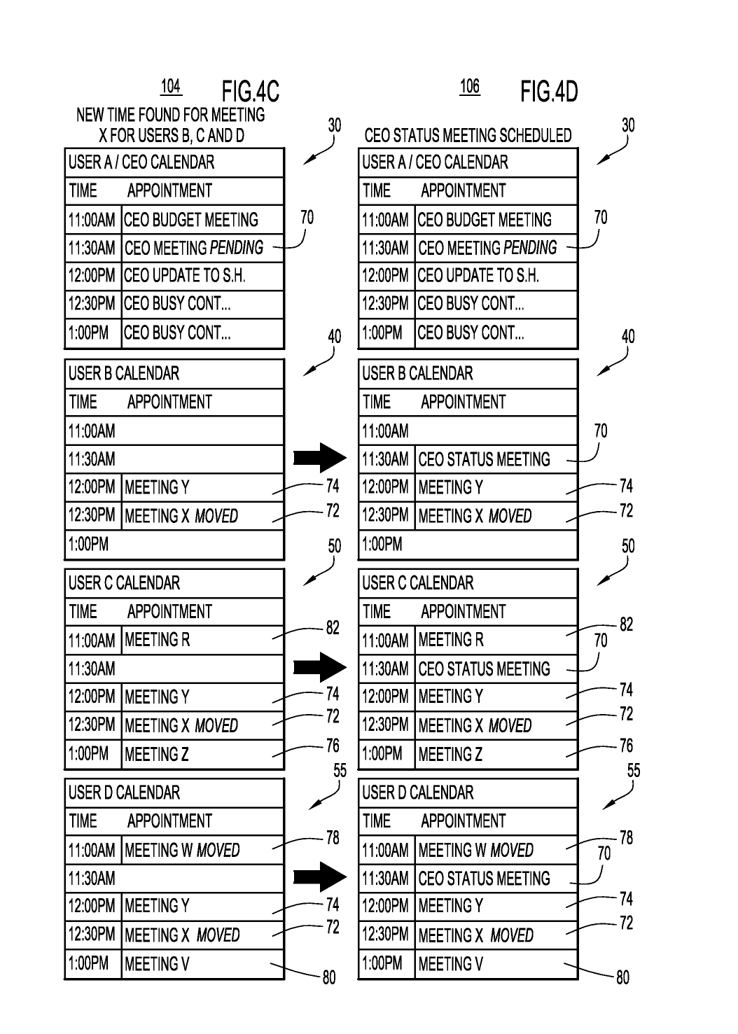

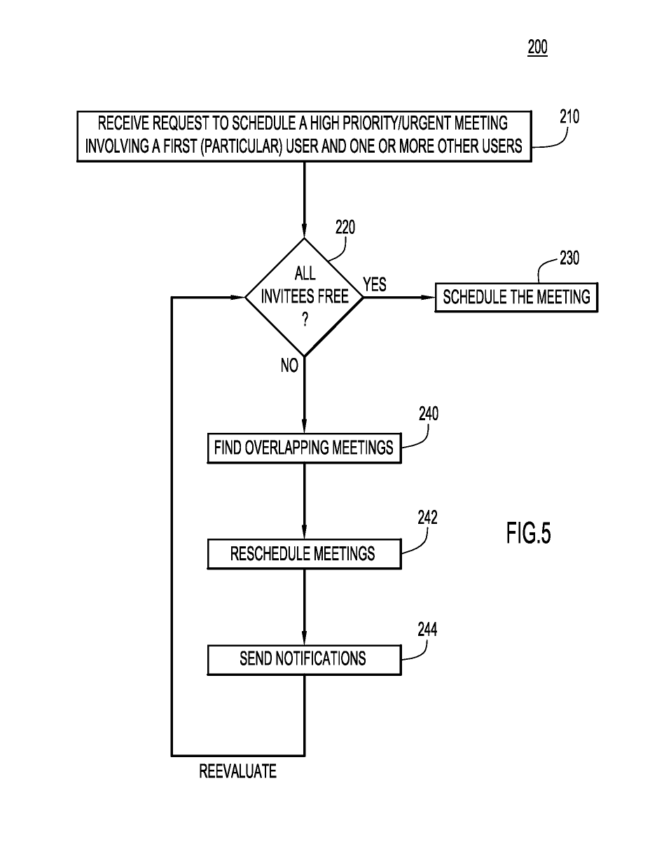

Turning now to FIGS. 4A-4D, another somewhat more complex rescheduling scenario is shown. FIGS. 4A-4D show an example of a scenario in which only one meeting conflicts with the high priority/urgent meeting, but in order to reschedule the conflicting meeting, another meeting that does not conflict with the high priority/urgent meeting, needs to be rescheduled. The scenario shown in FIGS. 4A-4D is similar to that of FIGS. 3A-3D in that user A has a high priority/urgent meeting 70 to schedule at 11:30 AM. Meeting X shown at reference numeral 72, involving users B, C and D is already scheduled for 11:30 AM and thus conflicts with user A's meeting 70 at 11:30 AM. Meeting Y shown at reference numeral 74 is scheduled for 12:00 PM, and involves users B, C and D. User C has Meeting Z shown at reference numeral 76 scheduled for 1:00 PM. User D has Meeting W shown at reference numeral 78 scheduled for 12:30 PM. Thus, in this example, Meeting W does not directly conflict with user A's urgent meeting 70. User D also has Meeting V shown at reference numeral 80 scheduled for 1:00 PM and user C has Meeting R shown at reference numeral 82 scheduled for 11:00 AM.

There are four phases/stages to the rescheduling scenario of FIGS. 4A-4D: phase 100 shown in FIG. 4A, phase 102 shown in FIG. 4B, phase 104 shown in FIG. 4C and phase 106 shown in FIG. 4D. At phase 100 in FIG. 4A, the initial meeting request is sent to and received at the meeting server 10 for user A's high priority/urgent meeting 70 at 11:30 AM involving users B, C and D. Upon searching through the stored data for calendars 30, 40 and 55, the meeting server 10 determines that Meeting X conflicts with meeting 70. At phase 102 in FIG. 4B, the meeting server 10 reschedules Meeting W involving user D to 11:00 AM. This is done in order to make available a time slot for rescheduling Meeting X, the only meeting in this scenario that conflicts with user A's high priority/urgent meeting 70, since Meeting X involves users B, C and D. At phase 104 in FIG. 4C, Meeting X is rescheduled to 12:30 PM (the originally scheduled time slot for Meeting W). Finally, at phase 106 in FIG. 4D, user A's high priority/urgent meeting 70 is scheduled at 11:30 AM, and updated meeting invitations/notifications are sent to users B, C and D for the rescheduling of Meeting X and a new meeting invitation/notification is sent to user D (and to all other participants, not shown in FIGS. 4A-4D) for the rescheduling of Meeting W.

Turning now to FIG. 5, a flow chart is shown for a process 200 performed to automatically reschedule meetings in order to accommodate a high priority/urgent meeting as represented in the scenarios of FIGS. 2A-2C, 3A-3D and 4A-4D. These operations may be performed by the meeting server 10 shown in FIG. 1, for example. At 210, a request is received to schedule a meeting between a first user and one or more other users that are meeting participants/attendees of the meeting. The meeting is, for example, a relatively high priority/urgent meeting perhaps sent on relative short advanced notice. For example, the meeting may be a “same day” meeting. The first user may be designated a “high” priority user, such as a senior executive in a business organization. This request may be generated by the first user's calendar client software when the first user, or his/her designee (assistant), sends a meeting invitation for a meeting to one or more other users. The high priority nature/status of the meeting request may be determined from a priori information stored for a particular user or from an indication specifically included in the meeting request made by/for any user (even if that user does not have a high priority status), as explained above.

At 220, the meeting server determines whether the one or more invitees to the meeting are free at that time. If so, then the meeting is scheduled at 230. In other words, at 220, the meeting server determines whether there is at least one other meeting involving any of the one or more other invitees/users that conflicts with the high priority/urgent meeting sought to be scheduled. If there is at least one other conflicting meeting, then the meeting server needs to do some searching through data for the calendars of the one or more users to reschedule one or more meetings in order to free the time slot for the meeting sought to be scheduled.

At 240, the meeting server searches data representing digital calendars for the plurality of users to determine whether this is at least one conflicting/overlapping other meeting involving any of the one or more users. At 242, the meeting server automatically reschedules the one or more conflicting/overlapping meetings to other time(s) in order to accommodate the high priority/urgent meeting. To do so, the meeting server searches schedule availability of the users who are designated to attend the one or more other meetings and selects a time slot for the one or more other meetings based on the search results. This may involve rescheduling one or more meetings that conflict with the high priority/urgent meeting as depicted by the scenarios in FIGS. 2A-2C and 3A-3D. Moreover, as in the example of FIGS. 3A-3D, when multiple other meetings conflict with the high priority/urgent meeting, automatically rescheduling involves rescheduling each of the multiple other meetings so they each do not conflict with the high priority meeting and do not conflict with each other with respect to any common users who are designated attendees of the respective multiple other meetings.

Further still, as in the case of the example of FIGS. 4A-4D, operation 242 may involve rescheduling one or more meetings that do not conflict with the high priority/urgent meeting, but need to be rescheduled in order to move/reschedule the one or more other meetings that conflict with the high priority/urgent meeting. When rescheduling meetings, the meeting server may attempt to reschedule those meetings within the same day or next day of the originally scheduled meetings. A parameter may be set in the meeting server to cause the rescheduling of meetings with a highest preference for the same day as the original meeting, then the next day if the same day is not possible, then the next day after that, and so on. Moreover, a preference may be set such that the same time of the originally scheduled meeting is chosen if it needs to be rescheduled to another day.

At 244, the meeting server sends notifications to the one or more users that are affected the rescheduling of meetings at 242. The notifications may take the form of meeting update notifications, and which indicate the new time for each rescheduled meeting. The rescheduling of meetings is done automatically, that is, without any human input from any of the meeting participants (or their assistants). This greatly reduces the time and effort on the part of meeting participants (or their assistants) to reschedule any of the meetings needed to accommodate the high priority/urgent meeting.

The meeting rescheduling techniques presented herein are particularly useful for scheduling meetings for senior executives who often have a less flexible schedule, but need to change meetings frequently or schedule meetings on a short notice. Moreover, a senior executive may need to schedule meetings that take priority over any other already scheduled meetings requested by less senior people in a given organization.

There may be criteria for the number of meetings that can be rescheduled/moved, as well as analysis of a relative level of priority when rescheduling meetings. For example, a meeting about acquiring another company that is time-sensitive would be given higher priority than a meeting about the company softball team. Moreover, a meeting about acquiring another company would be given higher priority than even a CEO's weekly status meeting, which otherwise would be given higher priority than any other meetings. These techniques may use these relative levels of priorities and/or other properties to determine whether a meeting can or cannot be moved.

Furthermore, a range of times to schedule the new high priority meeting may be specified and the calendar server may find or create an available slot in that range. For example, that time range may be to schedule the high priority meeting within the next 3-4 hours or the next day, or between 1 PM and 4 PM on a given day. For example, if the high priority meeting is 1 hour in duration, the calendar server would then search all time blocks of that duration, e.g., all 1 hour time blocks, in the specified range of times. Moreover, the calendar server may select the time slot for the high priority meeting so as to impact the smallest number of previously scheduled meetings and/or people in previously scheduled meetings. In other words, one time slot may be selected for the high priority meeting that requires rescheduling only one preexisting meeting over another time slot that requires rescheduling two preexisting meetings. Similarly, a time slot may be selected for the high priority meeting that requires rescheduling of one or more preexisting meetings that impacts the fewest number of people. Thus, in summary, a time slot may be selected for the high priority meeting within a range of times and so as to impact a minimum number of previously scheduled meetings and/or a minimum number of users in previously scheduled meetings.

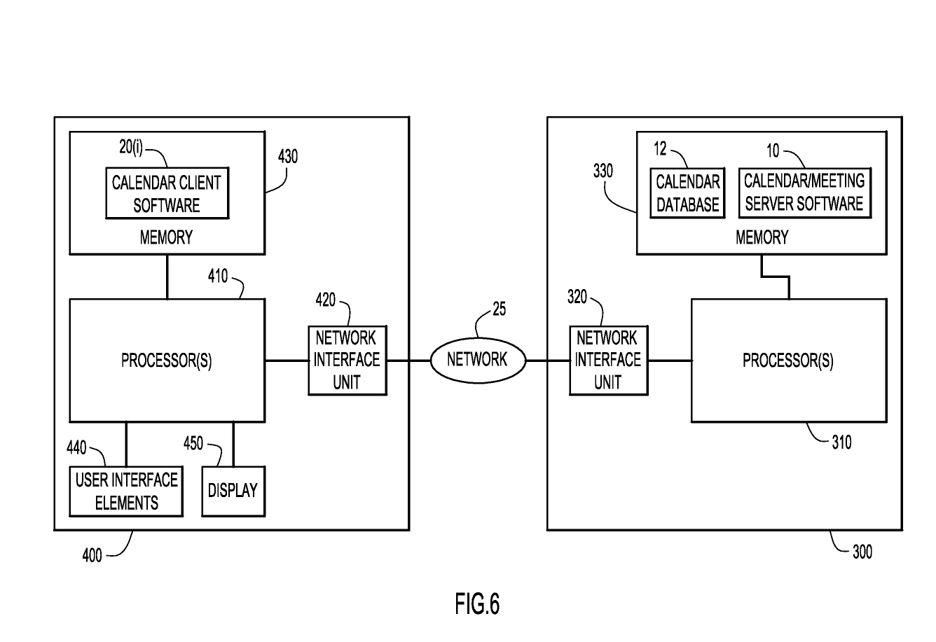

Turning now to FIG. 6, a more detailed block diagram is shown of equipment in which are hosted the meeting server 10 and calendar client generically identified by reference numeral 20(i). The meeting/calendar server software 10 and an associated calendar database 12 may be resident in a server computing apparatus 300 that includes one or more processors 310, a network interface unit 320 and memory 330 that stores the meeting/calendar server software 10. The calendar database 12 contains data representing up-to-date scheduling/calendars of all users. The meeting/calendar server software 10 may also store information indicating the relative priority status of one or more persons/users within an organization, and there may be multiple levels of priority status as explained above. The one or more processors 310 perform the operations described herein with respect to FIGS. 2A-2C, 3A-3D and 4A-4D when executing the meeting/calendar server software 10 stored in memory 330. The network interface unit 320 enables network communication over network 25.

The memory 330 may comprise read only memory (ROM), random access memory (RAM), magnetic disk storage media devices, optical storage media devices, flash memory devices, electrical, optical, or other physical/tangible memory storage devices. The one or more processors 310 consist, for example, of one or more microprocessors or microcontrollers. Thus, in general, the memory 330 may comprise one or more tangible (non-transitory) computer readable storage media (e.g., a memory device) encoded with software comprising computer executable instructions and when the software is executed (by the processor CPU 310) it is operable to perform the operations described herein for the meeting/calendar server software 10.

The calendar client 20(i) consists of software resident in a user device 400. The user device 400 includes one or more processors 410, a network interface unit 420, memory 430, user interface elements (e.g., mouse, keyboard, track-paid, touch-screen, etc.) 440 and display 450. The memory 430 stores instructions for the calendar client software 20(i). The calendar client software 20(i) is responsible for sending meeting requests to the calendar server software 10 and receiving notifications and other calendar data from the calendar server software 10 for display to a user.

As explained above, the calendar server and calendar clients may be implemented in a data center/cloud computing environment. In that case, the calendar server is a virtual machine residing in memory at a data center and each calendar client may also be a virtual machine residing at the data center.

In summary, a calendaring system and method is presented herein that automates meeting time availability searches and rescheduling/moving of meetings necessary to accommodate the scheduling of a meeting, e.g., a high priority/urgent meeting. The system and method searches all of the invitees/user's schedules for a meeting. If there is not an open time slot for all meeting attendees that overlaps, then the first available time slot is chosen that can be created by rescheduling other meetings. These other meetings are automatically rescheduled and updated meeting notifications for the rescheduled meetings are sent to the relevant meeting participants/users.

Currently available calendaring software allows people to view other people's schedules and can suggest the first open time slot, but there is no mechanism heretofore known for determining an open time slot that can be created by automatically rescheduling one or more other meetings. With current calendaring software, if there are no open time slots available for a high priority/urgent meeting, there is no way to schedule the high priority/urgent meeting without requiring a participant of that high priority/urgent meeting to either skip another meeting, or wait to schedule the high priority/urgent meeting until a time slot is available which could be days or weeks away.

The above description is intended by way of example only.

1. A method performed at a server that manages digital calendars for a plurality of users, comprising:
storing information indicating the status of the plurality of users within an organization;
receiving a request initiated by or on behalf of a first user to schedule a first meeting between the first user and one or more other users;
based on an analysis of the stored information indicating the status of the plurality of users, automatically assigning a relatively high priority to the first meeting based on the status of the first user within the organization;
selecting a time slot for the first meeting that conflicts with at least one other meeting involving any of the one or more other users;
based on an analysis of the stored information indicating the status of the plurality of users, automatically assigning a priority to the at least one other meeting that is relatively lower than the first meeting; and
automatically rescheduling the at least one other meeting to another time that does not conflict with the first meeting.

2. The method of claim 1, wherein the request to schedule the first meeting includes a time range during which the first meeting is to be scheduled, and wherein selecting a time slot for the first meeting comprising:
selecting a time slot for the first meeting within the time range that impacts a minimum number of previously scheduled meetings.

3. The method of claim 1, wherein the request to schedule the first meeting includes a time range during which the first meeting is to be scheduled, and wherein selecting a time slot for the first meeting comprising:
selecting a time slot for the first meeting within the time range that impacts a minimum number of users in previously scheduled meetings.

4. The method of claim 1, wherein automatically rescheduling comprises searching data representing calendars of the users who are designated to attend the at least one other meeting, and selecting a time for the at least one other meeting based on the searching.

5. The method of claim 1, wherein automatically rescheduling comprises rescheduling at least one meeting that does not conflict with the first meeting but which needs to be rescheduled to allow for rescheduling of the at least one other meeting that conflicts with the meeting being scheduled for the first user.

6. The method of claim 1, further comprising sending to users who are designated attendees of the at least one other meeting a notification indicating that the at least one other meeting is rescheduled to another time.

7. The method of claim 1, wherein determining comprises determining that there are multiple other meetings which conflict with the first meeting, and wherein automatically rescheduling comprises rescheduling each of the multiple other meetings so they each do not conflict with the meeting requested for the first user and do not conflict with each other with respect to any common users who are designated attendees of the multiple other meetings.

8. (canceled)

9. One or more non-transitory computer readable storage media encoded with software comprising computer executable instructions and when the software is executed operable to:
store, at a server that manages digital calendars for a plurality of users, information indicating the status of the plurality of users within an organization;
receive a request initiated by or on behalf of a first user to schedule a first meeting between the first user and one or more other users;
based on an analysis of the stored information indicating the status of the plurality of users, automatically assign a relatively high priority to the first meeting based on the status of the first user within the organization;
select a time slot for the first meeting;
search data representing digital calendars for a plurality of users to determine whether there is at least one other meeting involving any of the one or more other users that conflicts with the first meeting;
based on an analysis of the stored information indicating the status of the plurality of users, automatically assign a priority to the at least one other meeting that is relatively lower than the first meeting; and
automatically reschedule the at least one other meeting to another time that does not conflict with the first meeting.

10. The non-transitory computer readable storage media of claim 9, wherein the request to schedule the first meeting includes a time range during which the first meeting is to be scheduled, and wherein the instructions operable to select a time slot for the first meeting comprise instructions operable to:
select a time slot for the first meeting within the time range that impacts a minimum number of previously scheduled meetings.

11. The non-transitory computer readable storage media of claim 9, wherein the request to schedule the first meeting includes a time range during which the first meeting is to be scheduled, and wherein the instructions operable to select a time slot for the first meeting comprise instructions operable to:
select a time slot for the first meeting within the time range that impacts a minimum number of users in previously scheduled meetings.

12. The non-transitory computer readable storage media of claim 9, wherein the instructions operable to automatically reschedule comprise instructions operable to search data representing calendars of the users who are designated to attend the at least one other meeting, and to select a time for the at least one other meeting based on results from the search.

13. The non-transitory computer readable storage media of claim 9, wherein the instructions operable to automatically reschedule comprise instructions operable to reschedule at least one meeting that does not conflict with the first meeting but which needs to be rescheduled to allow for rescheduling of the at least one other meeting that conflicts with the meeting being scheduled for the first user.

14. The non-transitory computer readable storage media of claim 9, further comprising instructions operable to send to users who are designated attendees of the at least one other meeting a notification indicating that the at least one other meeting is rescheduled to another time.

15. The non-transitory computer readable storage media of claim 9, wherein the instructions operable to determine comprise instructions operable to determine that there are multiple other meetings which conflict with the first meeting, wherein the instructions operable to automatically reschedule comprise instructions operable to reschedule each of the multiple other meetings so they each do not conflict with the first meeting and do not conflict with each other with respect to any common users who are designated attendees of the multiple other meetings.

16. (canceled)

17. An apparatus comprising:
a network interface configured to enable communications over a network;
a memory configured to store data representing calendars for a plurality of users and to store information indicating the status of the plurality of users within an organization;
a processor coupled to the network interface and the memory, the processor configured to:
receive a request initiated by or on behalf of a first user to schedule a first meeting between the first user and one or more other users;
based on an analysis of the stored information indicating the status of the plurality of users, automatically assign a relatively high priority to the first meeting based on the status of the first user within the organization
select a time slot for the first meeting that conflicts with at least one other meeting involving any of the one or more other users;
based on an analysis of the stored information indicating the status of the plurality of users, automatically assign a priority to the at least one other meeting that is relatively lower than the first meeting; and
automatically reschedule the at least one other meeting to another time that does not conflict with the first meeting.

18. The apparatus of claim 17, wherein the processor is configured to automatically reschedule the at least one other meeting by searching data representing calendars of the users who are designated to attend the at least one other meeting, and selecting a time for the at least one other meeting based on results from the search.

19. The apparatus of claim 17, wherein the processor is configured to automatically reschedule the at least one other meeting by rescheduling at least one meeting that does not conflict with the first meeting but which needs to be rescheduled to allow for rescheduling of the at least one other meeting that conflicts with the first meeting.

20. The apparatus of claim 17, wherein the processor is configured to generate notifications to be sent to users who are designated attendees of the at least one other meeting, the notification indicating that the at least one other meeting is rescheduled to another time.

21. The apparatus of claim 17, wherein the processor is configured to determine that there are multiple other meetings which conflict with the first meeting, and to automatically reschedule each of the multiple other meetings so they each do not conflict with the first meeting and do not conflict with each other with respect to any common users who are designated attendees of the multiple other meetings.

22. The apparatus of claim 17, wherein the request to schedule the first meeting includes a time range during which the first meeting is to be scheduled, and wherein to select a time slot for the first meeting the processor is configured to:
select a time slot for the first meeting within the time range that impacts a minimum number of previously scheduled meetings.

23. The apparatus of claim 17, wherein the request to schedule the first meeting includes a time range during which the first meeting is to be scheduled, and wherein to select a time slot for the first meeting the processor is configured to:
select a time slot for the first meeting within the time range that impacts a minimum number of users in previously scheduled meetings.
